(19) United States
(12) Patent Application Publication
(10) Pub. No.: US 2015/0294090 A1
(43) Pub. Date: Oct. 15, 2015

(54) SYSTEM AND METHOD FOR CREATING AND DISTRIBUTING A HEALTHCARE RESEARCH AND DATA COLLECTION APPLICATION

(71) Applicants: Manu KODIYAN, San Francisco, CA (US); GREG COHEN, Sunnyvale, CA (US)

(72) Inventors: Manu KODIYAN, San Francisco, CA (US); GREG COHEN, Sunnyvale, CA (US)

(21) Appl. No.: 14/531,980

(22) Filed: Nov. 3, 2014

Related U.S. Application Data
(60) Provisional application No. 61/899,292, filed on Nov. 3, 2013.
(60) Provisional application No. 61/913,350, filed on Dec. 8, 2013.

(51) Int. Cl. G06F 19/00; G06F 17/30

(52) U.S. Cl. CPC G06F 19/363; G06F 17/30312

(57) ABSTRACT

A method includes the step of implementing a computerized health-care related template definition platform. The health-care related template definition platform comprises a computing platform on which a computerized health-care related template application is implemented and managed. The health-care related template definition platform is accessed by user-side computing device via the health-care related application operating, in the user-side computing device or via a web-page interface accesses by a web browser operating in the user-side computing device. A step includes providing a health-care related template. The health-care related template comprises a set of health-care related measurements that are tracked for a disease and/or a health goal. The health-care related template is implemented without a central-study administrator that decides the health-care related measurements that are tracked by the health-care related template. A step includes presenting the health-care related template to a user via the health-care related application. A step includes allowing a user to use multiple templates to track multiple healthcare goals. A step includes the ability of a user to customize template for their own needs. A step includes a rating system for a user to see which healthcare templates are highly rated by other users and experts.

### CROSS-REFERENCE TO RELATED APPLICATIONS

This application is a claims priority to U.S. provisional patent application No. 61/913,350, titled SYSTEM AND METHOD OF CROWD-SOURCED LONGITUDINAL HEALTHCARE RESEARCH and filed on 8 Dec. 2013 and U.S. provisional patent application No. 61/899,292, titled SYSTEM AND METHOD OF CROWD-SOURCED LONGITUDINAL HEALTHCARE RESEARCH and filed on 3 Nov. 2013. These provisional applications are hereby incorporated by reference in their entirety,

### BACKGROUND

1. Field

This application relates generally to the health care, and more particularly to a system, method and article of manufacture of crowd-sourced healthcare research and/or analysis system.

2. Related Art

There are a number of methods of tracking health-related information of people. Many of these methods may utilize various self-reports means such as user surveys, questionnaires, etc. These methods can involve requiring a user (e.g. a patient, a caregiver of a patient, a health-study participant, etc.) to fill in multiple forms several times over a period of time. Many of these applications are custom created and require significant amount of software and information technology personnel and server resources to put together. Creating custom applications is a time consuming and expensive process which puts them beyond the budget of many researchers leave alone lay people with an interest in tracking health. By creating a method that allows people to create health tracking applications a) without any programming knowledge or b) needing any information technology personnel or resources and c) having them run on any consumer grade smartphones and also web browsers; makes the method easily accessible by both experts and lay people thus helping in the gathering of patient reported health data and advancing the pursuit of health knowledge. Finally letting healthcare experts and interested lay people define and package what needs to be tracked in an area of healthcare they are interested for another person to avail of the packaging (also called a ‘template’) will make it easy for others to avail of their learning and expertise.

### BRIEF SUMMARY OF THE INVENTION

A method includes the step of implementing, with at least one processor, a computerized health-care related template definition platform. The health-care related template definition platform comprises a computing platform on which a computerized health-care related template application is implemented and managed. The health-care related template definition platform is accessed by user-side computing device via the health-care related application operating in the user-side computing device or is a web-page interface accesses by a web browser operating in the user-side computing device. A step includes providing a health-care related template. The health-care related template comprises a set of health-care related needs that are tracked for a disease and/or a health goal. The health-care related template is implemented without a central-study administrator that decides the health-care related needs that are tracked by the health-care related template. A step includes presenting the health-care related template to a user via the health-care related application. A step includes receiving a set of health-care related needs that are tracked for a specific disease and/or a health goal. The set of health-care related needs are determined by at least one user of with the health-care related template application. A step includes storing the set of health-care related needs as metadata in a database. A step includes providing a metadata interpreter functionality to the user-side computing device. The metadata interpreter functionality accesses the metadata and render the metadata for display on the user-side computing device display system.

Optionally, the health-care related template application can be associated with a health issue of the user. The user can have more than one disease or health goal. A step can include providing a plurality of health-care related templates. Each health-care related template can include a set of health-care related measurements that are tracked for a specific disease and/or a health goal. The metadata interpreter can functionality access the metadata from each of the plurality of health-care related templates and renders the metadata for a unified display on the user-side computing device display system. The metadata can be stored in an Extensible Markup Language (XML) format, JavaScript Object Notation (JSON) format or any other computer interpretable markup format. The user can take a template and customize it for their use.

### BRIEF DESCRIPTION OF THE DRAWINGS

The present application can be best understood by reference to the following description taken in conjunction with the accompanying figures, in which like parts may be referred to by like numerals.

FIG. 1 illustrates a schematic depiction of various computer systems that may be used to implement various embodiments.

FIG. 2 illustrates an example representation of a data entry screen used to create a study or template, according to some embodiments.

FIG. 3 illustrates an example representation of a data entry screen used to capture details about a qualifying criterion for a study or template, according to some embodiments.

FIG. 4 illustrates an example representation of a data entry screen used to capture details about an item or symptom to track within a study, according to some embodiments.

FIG. 5 illustrates an example representation of a data entry screen used to capture details about the measurements or observations to be captured for a tracked item and/or symptom, according to some embodiments.

FIG. 6 illustrates an example representation of a data entry screen used to capture details about the measurements and/or observations to be captured in a study, according to some embodiments.

FIG. 7 illustrates an example representation of the screen that may be seen by participants of the study listing the items to be tracked and a way to input measurements or observations across days, according to some embodiments.

FIG. 8 illustrates an example representation of a screen used to let study participants create and/or modify multiple measurements and/or observations for the same day, according to some embodiments.

FIG. 9 illustrates an example representation of a measurement and observation screen as seen by a study participant, according to some embodiments.

FIG. 10 illustrates an example representation of a screen that can be used by a study participant to capture the time at which the measurement and/or observation was made, according to some embodiments.

FIG. 11 illustrates an example representation of a screen where a creator of a study can define the symptoms, activities, side effects, health indicators, therapies and/or medications that be tracked for a study, according to some embodiments.

FIG. 12 illustrates an example representation of the screen that may be seen by participants of a study listing the symptoms, activities, side effects, health indicators, therapies and/or medications to be tracked and a way to input compliance across multiple days, according, to some embodiments.

FIG. 13 illustrates an example representation of a screen that lets study participants create and/or modify multiple instances of administration of a therapy and/or medication on the same day or log symptoms, activities, or side effects, according to some embodiments.

FIG. 14 illustrates an example representation of a screen that can be used by a study participant to capture the time at which the symptom occurred, the side effect was felt, or therapy was administered, according to some embodiments.

FIG. 15 illustrates an example representation of a screen used to define events or changes to an intervention to be tracked during the course of a study, according to some embodiments.

FIG. 16 illustrates an example representation of a screen that can be used by a study participant to list all the events in a study, according to some embodiments.

FIG. 17 illustrates an example representation of a screen that can be used by a study participant to capture the time at which the event was actually completed, according to some embodiments.

FIG. 18 illustrates an example representation of a screen that displays reminders to a study participant for an upcoming or overdue activity, according to some embodiments. The study participant can be alerted about reminders waiting in the application even while they are not using the application. The application can use any alerting system made available by the computer system on which the application is running.

FIG. 19 illustrates an example representation of a screen that may he used to display the results of the study, according to some embodiments.

FIG. 20 illustrates an example process of obtaining user health information via a health-tracker application in a mobile device, according to some embodiments.

FIG. 21 depicts an exemplary system for implementing, a crowed-sourced healthcare research system, according to some embodiments.

FIG. 22 depicts an exemplary computing system that can be configured to perform any one of the processes provided herein.

FIG. 23 is a block diagram of a sample computing environment that can be utilized to implement some embodiments.

Another embodiment of the system in FIG. 2 is shown in FIG. 24, according to some embodiments.

FIG. 25 shows one embodiment of a ‘Template Deployment System’, according to some embodiments.

FIG. 26 illustrates an example process of deploying health-care related templates, according to some embodiments.

The Figures described above are a representative set, and are not an exhaustive with respect to embodying the invention.

### DESCRIPTION

Disclosed are a crowd-sourced healthcare research and/or analysis system, method, and article of manufacture. Although the present embodiments have been described with reference to specific example embodiments, it can be evident that various modifications and changes may be made to these embodiments without departing from the broader spirit and scope of the particular example embodiment. The healthcare research can be longitudinal healthcare research. The term longitudinal in the title indicates that the research can run for a period of time and the research participant can interact with an embodiment described here. As opposed to single surveys that are tilled out once or multiple times over a period of time.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, attendee selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed, are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Although the present embodiments have been described with reference to specific example embodiments, it can be evident that various modifications and changes may be made to these embodiments without departing from the broader spirit and scope of the invention.

Definitions

Application store can be a type of digital distribution platform for mobile applications.

A health-care related template definition platform can be a computing platform and/or framework on which health-care related applications may be run. A health-care related template definition platform can be accessed by user-side computing devices via a health-care related application and/or web-page interface.

HTML5 (HyperText Markup Language) can be a core technology markup language of the Internet used for structuring and presenting content for the World Wide Web

Longitudinal study can be a correlational research study that involves repeated observations of the same variables over periods of time.

JavaScript Object Notation (JSON) is a markup language that defines a set of rules for encoding documents in a format that is both human-readable and machine-readable.

A ‘native’ application is a computing application resides on a user-side computing device and can also have a local database on the user-side computing device. The native application can run without a wireless or cell phone connection so that the user can use it at any time to avail of alarms, reminders, data entry and reporting capabilities.

A ‘template’ is the packaging of specific health data that needs to be tracked for a specific health condition or health goal. An expert of interested lay person puts together what needs to be tracked and then gives the package a name and a description. This method and/or platform allows for these templates to be made available for others to download and use for their own purposes.

A ‘study’ and templates can in some ways be used interchangeably a study is the packaging of specific health data that needs to be tracked for a specific health condition or health goal. However in the case of a study there is usually a study administrator who wants to gather and analyze the data from several study participants. The study administrators often are not interested in making the study available for distribution as a package for others to use for themselves.

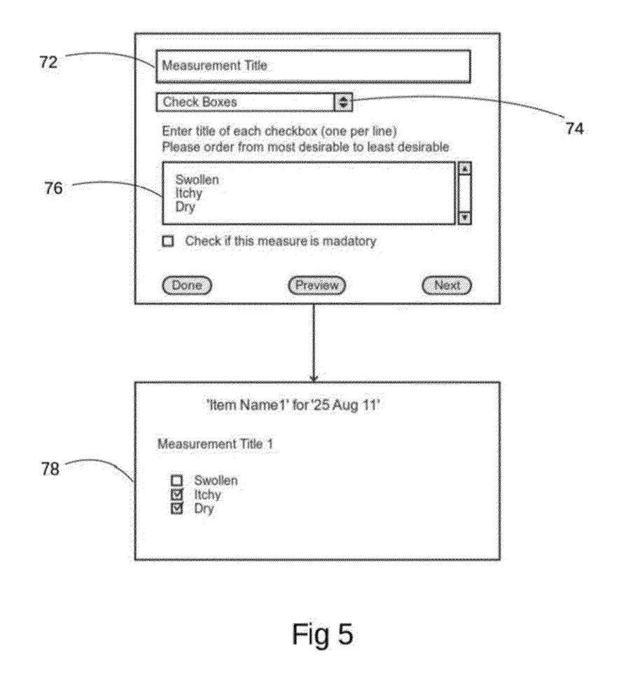

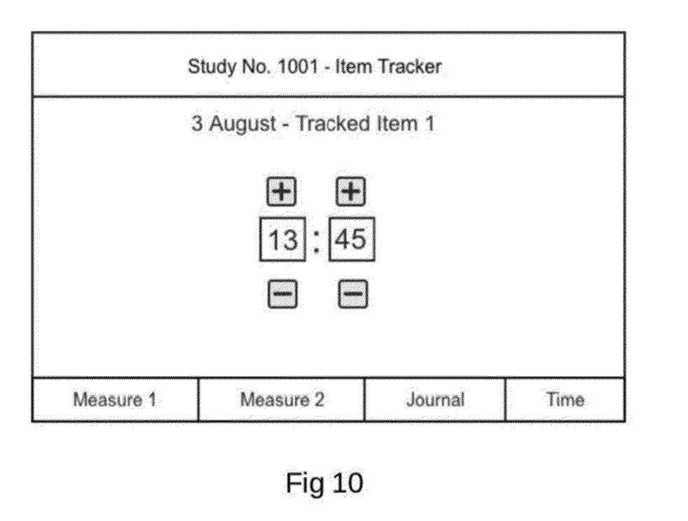

A ‘metadata interpreter’ is a computer system that can take metadata about template or a study and then configure an application running on a user-side computing device. This way each user can have a custom user interface based on their interests. For example, FIG. 5 illustrates how the metadata can be created about a measure that needs to be captured and FIG. 9 illustrates how the metadata interpreter renders a screen for a user of the application from metadata transmitted so that a user can enter some health measurement. A metadata interpreter will be created for each environment the interpreter can run in, e.g. iOS or Android environment. Thus once the metadata interpreter is created for an environment then all studies/templates can run in that environment.

Example Processes and Systems

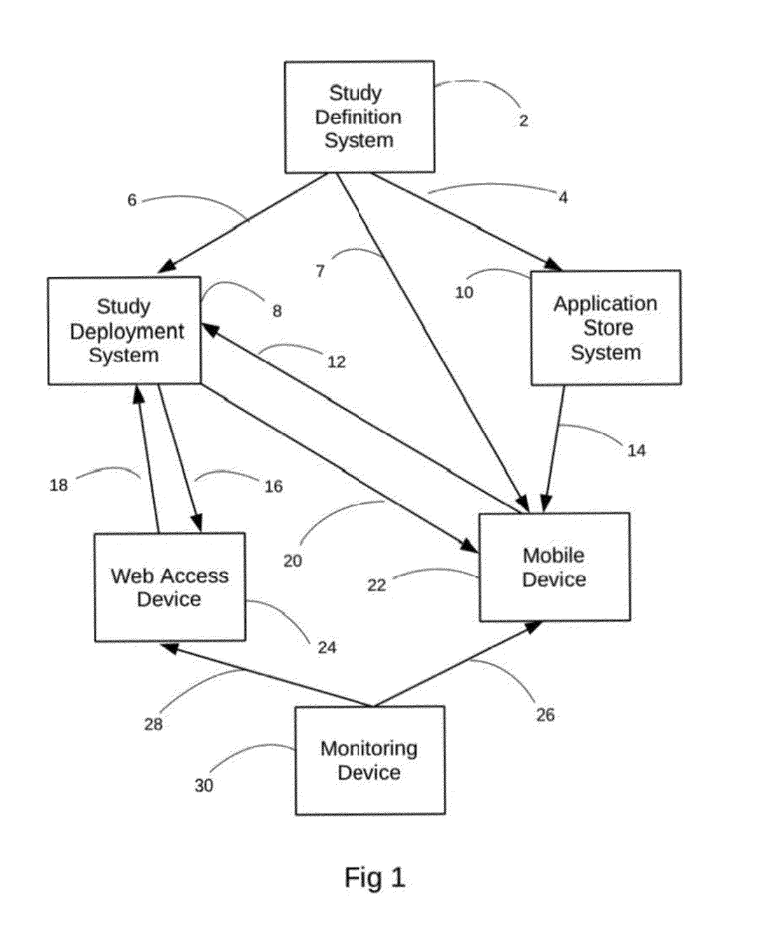

FIG. 1 illustrates a schematic depiction of various computer systems that may be used to implement various embodiments. Referring to FIG. 1, study-definition system 2 can implement a software program that enables the definition and/or creation of a study (e.g. a health-care study, a longitudinal health-care study, etc.). A healthcare study can include the creation of a system for gathering specified health-observation data from various study participants. The data can be gathered over a period of time and include surveys and other tracked items that may be answered multiple times by study participants during the course of a study. The study data from all study participants can then be aggregated and analyzed. Once the study is defined, it can be deployed to a computer system, such as study deployment system 8, for access by study participants. Once a study is defined in study-definition system 2 it can he stored in a metadata format. The metadata may be stored in one or more formats, such as records in data tables, XML files, JSON files, etc. Study deployment system 8 can be implemented with a web server version of a ‘metadata interpreter’ program that accesses the metadata 6 and can interpret the metadata and display the study information. The ‘metadata interpreter’ can create and manage the interfaces that enable for the participants to sign up and take part in a study.

Given advances in computer technologies involving virtual machines, cloud computing and powerful mobile computers when this document refers to a system, it may be a logical system that performs a given function. There may be one or more physical computers mapped to a logical system.

Participants may access the study via any web access device 24 (e.g. a smart phone, a tablet computer, a head-mounted computing system, etc.). Web access device 24 can include a web browser that supports rendering an application downloaded either as HTML and/or XML data 16. The HTML or XML may be generated by the ‘metadata interpreter’ program deployed on study deployment system 8. When a participant accesses the web browser version of the study data input by participants, the web access device may store the data 18 in a remote database on the study deployment system 8.

The participant can also download a native ‘metadata interpreter’ application specially created for a mobile communication and computing device 22. These native applications can be created using a software development kit (SDK) supported by the enterprise providing computing device 22. The native application may download metadata 7 to render the study in the native application. Even while using a native device, some or all of the screens may be rendered using XML/HTML downloaded 20 from study deployment system 8. In one embodiment, device 22 can be a consumer device owned by the research participant (i.e. a user). This may be distinct from clinical research conducted by pharmaceutical companies who supply a special device to the study participant to record their health observations.

In some embodiments, an enterprise selling a mobile communication and computing device may include the native application that runs the studies be downloaded 14 from a seller specific application store 10. In such an example, the study participant (i.e. the user) may download the native application from a seller specified application store. As such, the application can be uploaded 4 prior to the study being conducted.

In most cases, when using mobile communication and computing devices, the observations, measurements and/or therapy administration information can be captured in a local database. This can enable the study to be accessible even when the mobile or wireless signal strength is weak or non-responsive. The system can periodically synchronize individual study results 12 to a remote study deployment system 8 when connectivity to the server is established. It is noted that the study deployment system of FIG. 1 can aggregate data from multiple study participants.

In some embodiments, participants (i.e. users) using a mobile device 22 may select to use the study application rendered in a web browser. In this case, the application may be stored in a local database using implementations of HTML5 and/or versions of web technologies (e.g. other versions of HTML, other markup languages such as other markup languages for used for structuring and presenting content for the World Wide Web, etc.). The application can be synchronized periodically 12 with a remote database. However, in some embodiments, the application may also be configured on the device without any local storage, in this case, study data input by participants may be stored 12 directly in a remote database (e.g. managed by the study deployment system 8). It is noted that remote servers and/or remote databases can be implemented in a cloud-computing environment in some embodiments.

There may be also instances where a monitoring device 30 can monitor environmental conditions and/or a participant's physical state/biological attributes. Monitoring device 30 can transmit the data through either a wired connection and/or a wireless connection 26 to a mobile communication and computing device 22 (e.g. with a wireless protocol such as Bluetooth®). Monitoring device 30 may similarly connect 28 to an application running on a web access device 24, this application is typically provided by the manufacturer of device 30. In some embodiments the monitoring device data may be captured, inter alia, either via an application programming interface (API) from device manufacturer and/or scraped from the device manufacturer's web site.

While this embodiment describes uses in the healthcare field, a variation of the embodiment can also be used in product research. In that case, monitoring device 30 can be attached to a particular product. The mobile communication and computing device 22 can then communicate with the monitoring device 30 attached to a product in close proximity via wireless communication 26. This can enable the embodiment to prompt a research participant relevant questions about the state of the product and the research participant's interaction with it.

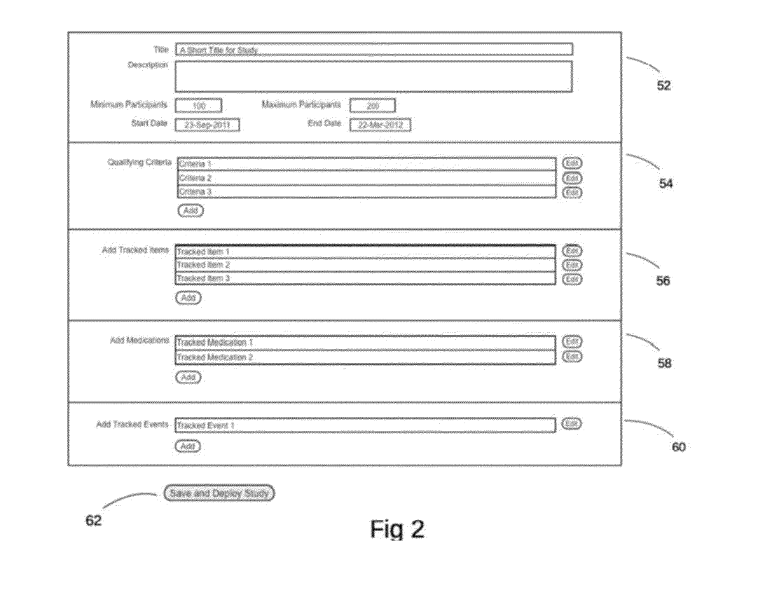

FIG. 2 illustrates an example representation of a data entry screen used to create a study, according to some embodiments. Referring now to FIG. 2, depicts one possible design for a screen to define a study. The initial set of fields shown may be used to define the study. For example, it may give a study a name, description, minimum and maximum number of participants, start and end dates, and more. This is not a complete list of information that may be captured about a study but just a representative sample.

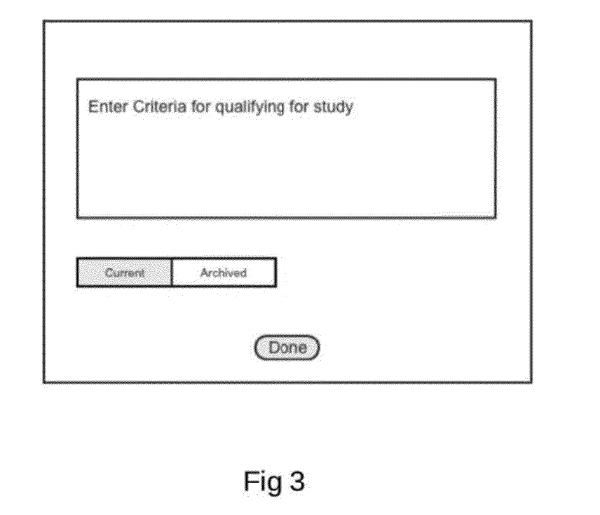

Still referring to FIG. 2, one or more qualifying criteria for a study are shown. For example, various input fields can be provided whereby the study participant may attest to the fact that he/she qualifies for the study. A new criteria may be added using the add button while an existing criteria may be edited by clicking the edit button in level with each criterion. The study creator can create as many qualifying criteria as required. For example, FIG. 3, infra, shows a potential screen to capture a criterion that may be later listed as a requirement for participating in the study.

Continuing to refer to FIG. 2, a study creator can add items (e.g. activities, symptoms, side effects, therapies, medicines, health indicators such as weight) to be tracked for the study. The study creator can create as many items to track as they want. A new item may be added by clicking on the add button in block 56. An existing item may be edited by clicking on an edit button associated with an item.

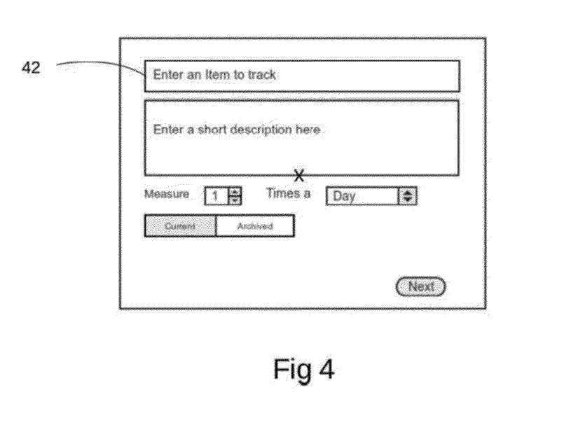

FIG. 3 through FIG. 6 depict additional details of one potential method for a study creator not knowledgeable in computer programming to specify information to be measured for each item to be tracked. FIG. 3 illustrates an example representation of a data entry screen used to capture details about a qualifying criterion for a study, according to some embodiments. FIG. 4 illustrates a possible design for capturing the title 42, description and other details for an item or symptom that needs to be tracked. FIG. 5 illustrates how a study creator can specify what measurements need to be captured for an item or symptom created as shown in FIG. 4. The study creator can specify a title 72 for a measurement, such as ‘pain level’. After, the study creator can select what format a participant of a study can input measurements. One way to specify the type of input can be by making a selection from a drop down menu 74. The selection shown as chosen in FIG. 5 can be a type of Check Box. The names displayed against each of the check boxes may be specified within a text area 76. By clicking on a preview button the study creator may have the ability to see in a preview area 78, how the measurement input interface ma look like to a study participant when the study is saved and deployed. The study creator can setup multiple measurements to be tracked for the same item or symptom being tracked. The drop down menu 74 may have many other types of values that pertain to different types of measurements and input formats. Listed below is a representative but not an exhaustive list of types of input possible for a measurement.

| Measure Type | Description |
|---|---|
| Check Box | Multiple named check boxes. The study participants can check zero or |
| | more check boxes. |
| Radio Button | Multiple named radio buttons. The study participants can check any one |
| | radio button. |
| Numeric Entry | The study participant can enter a numeric value for the measurement. |
| Text Entry | The study participant can enter one line of text for the measurement. |
| Multi-line Text Entry | The study participant can enter multiple lines of text for the |
| | measurement. |
| Counters | The study participant can increment a counter, for example every time |
| | they have a cigarettes or decrement counter against a daily budget of |
| | enabled cigarettes. |
| Health specific | Health specific measure types are used to capture measurements such as |
| | blood pressure, pulse rate, height, weight, blood glucose, etc. |
| Data feed | Device data, such as pedometer measurements, heart rate, etc. can be |
| | directly captured as well as environmental data such as air temperature |

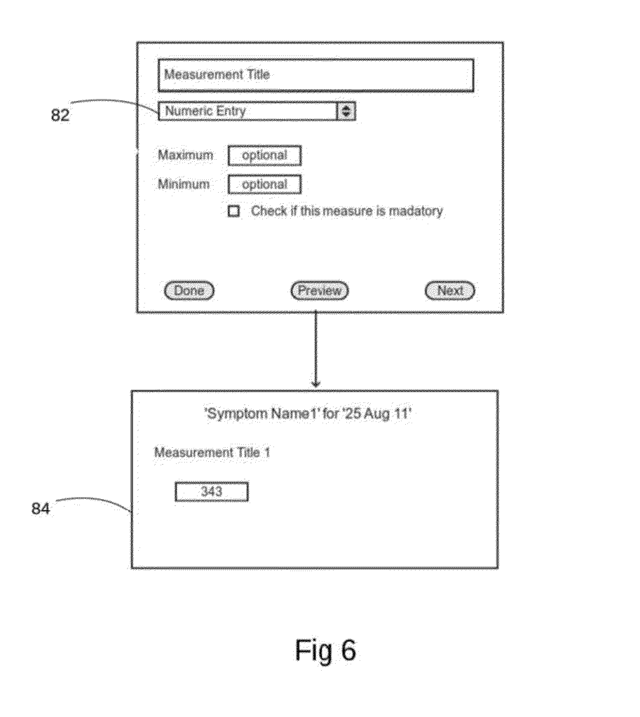

FIG. 6 illustrates an example of use case that allows a study creator to set up a numeric measurement to be elicited from study participants. The study creator can select a numeric entry from drop down 82. The study creator can also capture other relevant information about the numeric measure elicited such as, inter alia, a valid minimum and maximum range. The study creator can see a preview 84 by clicking on the preview button.

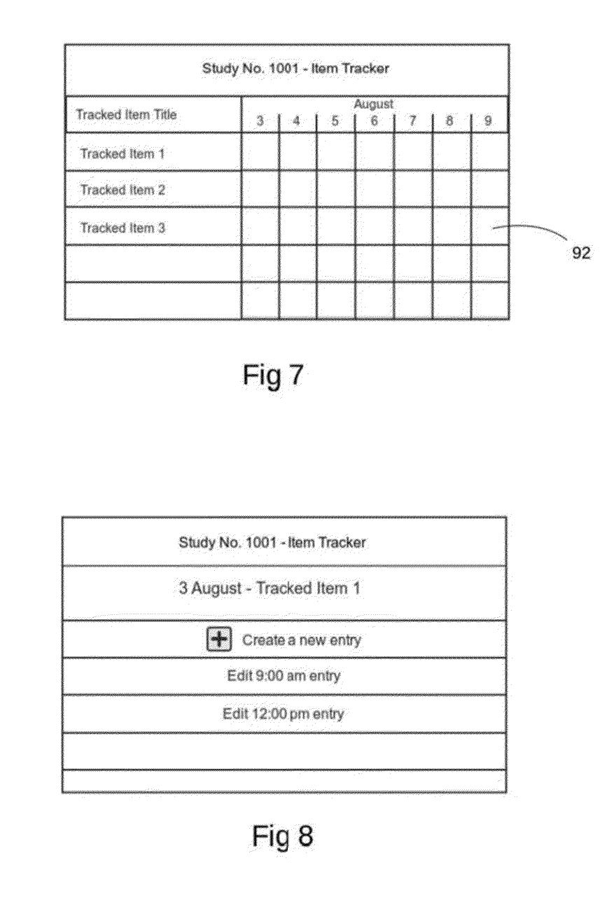

FIGS. 7-10 depict an example use the metadata captured while a study is created to generate a user interface either on a web browser or on a native application rendered on a mobile computing device. For example, a ‘metadata interpreter’ web server application can render the user interface for a study for a web browser. Native ‘metadata interpreter’ applications on mobile communication and computing devices may tender the user interface on specific devices.

FIG. 7 shows one possible interface to enable study participants to see a listing of items or symptoms to track against the days of the calendar. The user can click on the intersection cell of day and an item or symptom to enter a measurement. For example, 92 are at the intersection of an item or symptom called ‘Tracked Item 3’ and 9th August. There can be many ways in which the user can scroll through the calendar or a list of items or symptoms being tracked. On touch devices the user may swipe left and right or up and down. On non-touch devices there may be buttons the user can click (not shown in FIG. 7) or drag (e.g. with a mouse input device) left, right, up or down with a mouse button clicked. When a measurement is completed, the cell in question can be updated with a suitable notation to indicate there are one or more measurements for that cell (notation not shown in FIG. 7).

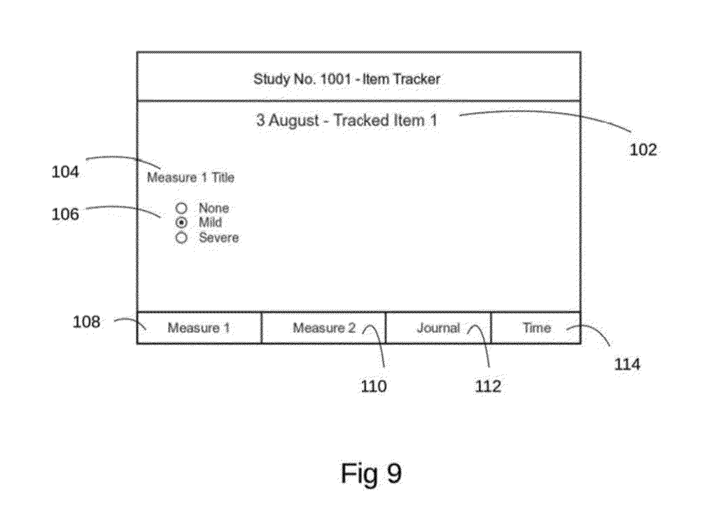

FIG. 8 shows a screen that may be displayed when cell 92 is clicked in FIG. 7. This is one way to enable study participants to create multiple measurement entries in one day. All previously created entries for the day may be presented in a list and the user can scroll through the list and select a measurement to edit or create a new measurement by clicking on a create new entry row. Depending on whether the participant is on a touch device or non-touch device, the participant can either tap using fingers or use a mouse.

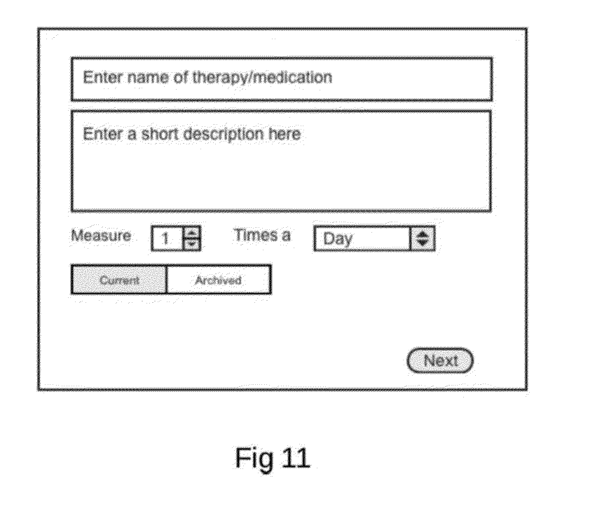

FIG. 9 shows what a measurement capture interface for an item or symptom may look like. This screen may be rendered from the meta-data created during the study definition. The measurement entries created by study participants may be aggregated collated and published by the study management and study publishing programs that may run on the Study Deployment System 8 in FIG. 1. 102 is a combination of the date for which the measurement is being made and the title of the item or symptom for which the measurement is being tracked. Ann example may be ‘23 August—Back Pain’. 104 is the title of the measure, Example—‘Pain Level’. 106 is a radio button used for input; the user may select one of the options. 108 through 114 shows a way of capturing multiple elements and measurements associated with the same item or symptom via a multiple tab interface. 108 and 110 are two different measures defined by the study creator. 112 is a journal tab used for participants to create an optional journal entry for the measurement. 114 is a tab to edit the time recorded for the measurement. FIG. 10 is displayed when tab 114 in FIG. 9 is tapped or clicked and shows the edit time interface in more detail.

Referring again to FIG. 2, block 58 may enable a study creator to add and edit therapies and medications that need to be administered as part of the study. The Add button in block 58 enables a study creator to add a new therapy or medication, while the edit button may enable a therapy or medication detail to be edited. The study creator can create as many therapies or medications to track as they like. If a study is underway the study user interface generated for a study participant can change and the study participant can be notified of the change so that they are aware of the changes. The notification may be via the generated study participation application and/or via other means of communication such as email or text messaging.

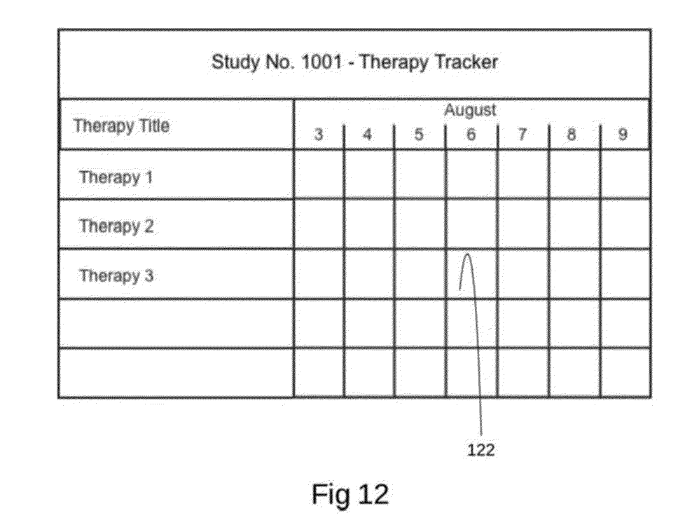

FIG. 11 shows a possible design for capturing the name and description and a few other details for a therapy or medication that needs to be tracked for the study.

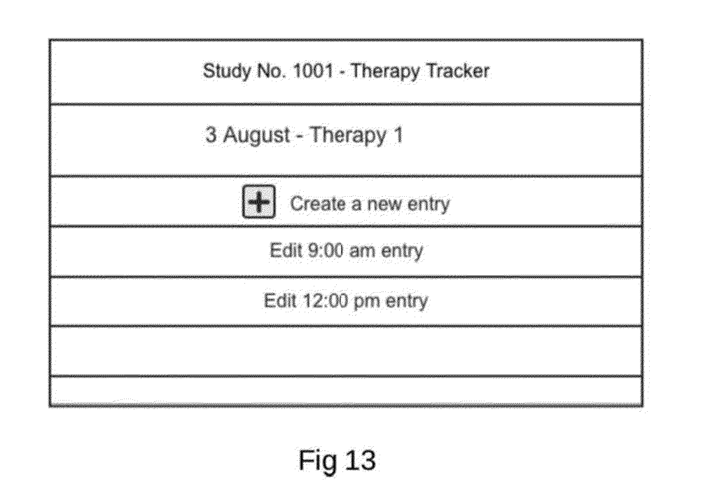

FIG. 12 shows one possible interface to enable study participants to see a listing of therapies or medications to track against the days of the calendar. The calendar number of days shown can he variable. The user can click on the intersection cell of day and a therapy or medication to record the administration of a therapy or medication. Example—112 is at the intersection of therapy called ‘Therapy 3’ and 6th August. There can be many ways in which the user can scroll through the calendar or a list of therapies or medications being tracked. On touch devices the user may swipe left and right or up and down. On non-touch devices there may be buttons (not shown in FIG. 12) the user can click or drag the mouse with a mouse button clicked. When an administration of a therapy or medication is completed the cell in question can be updated with a suitable notation (notation not shown in FIG. 12) to indicate there are one or more administrations for that cell.

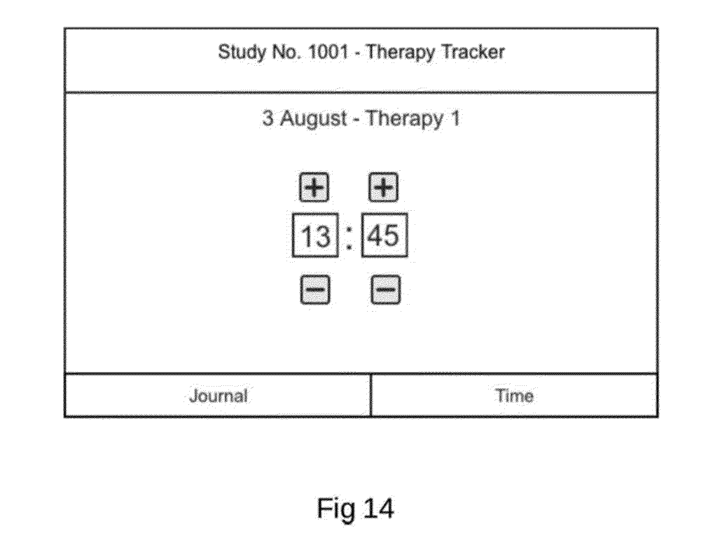

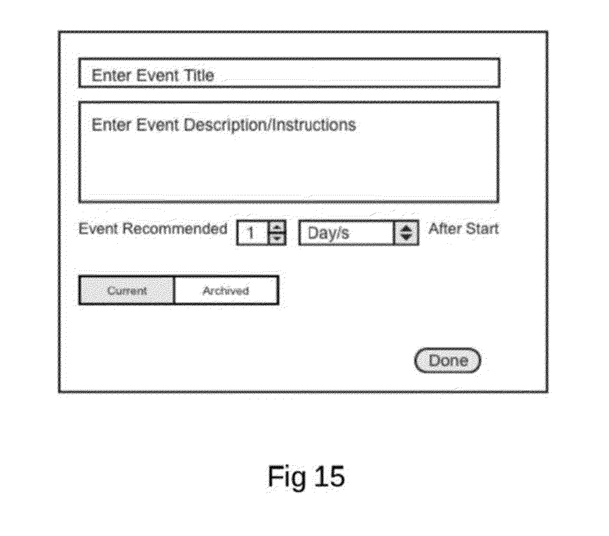

FIG. 13 shows a way to enable study participants to capture multiple therapy or medication administration entries in one day. All previously created entries for the day may be presented in a list and the user can scroll through the list and select an administration instance to edit or create a new administration instance by clicking on a create new entry row. Depending on whether the participant is on a touch device or non-touch device the participant can either tap using fingers or use the mouse. FIG. 14 shows an interface to enable study participant to edit the time of administration.

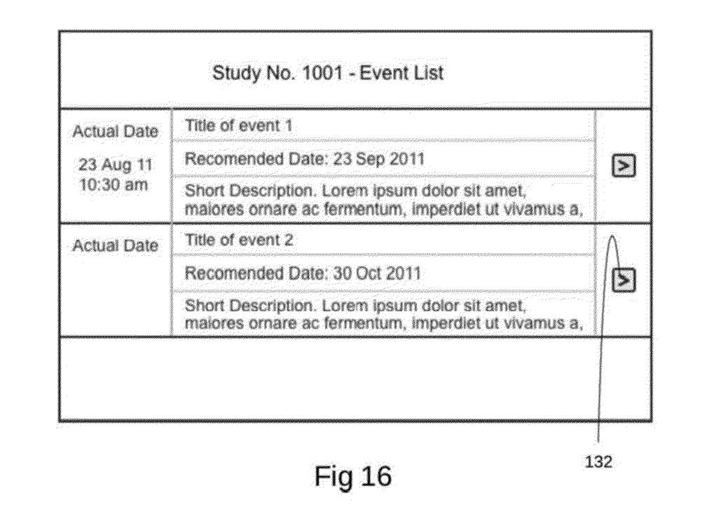

Referring back to FIG. 2 block 60 may enable study creators to define events that need to be tracked as part of a study. Example—an event may be “Take a blood glucose level test ninety days after start of study”. The Add button enables the study creator to create new events while the Edit button enables users to edit an existing event. A study creator may create as many events as needed. FIG. 15 shows a screen that may be used by a study creator to create or edit an event.

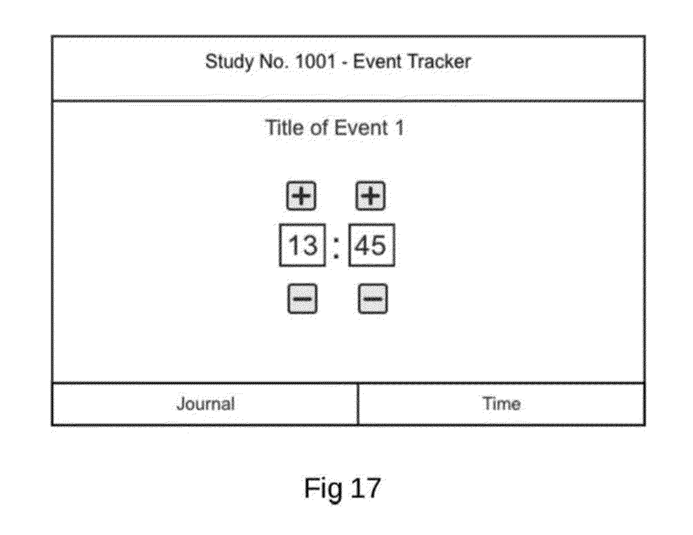

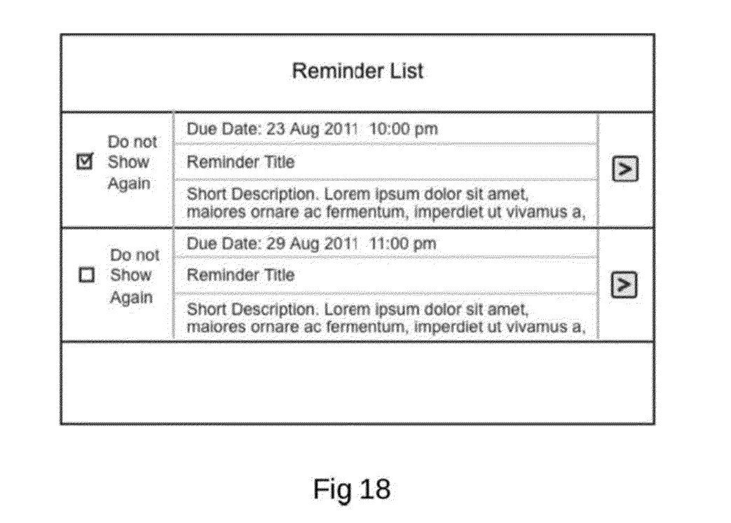

FIG. 16 shows a screen that can be used to display all the events in a study to a study participant. The study participant can click or tap the button 132 to edit details of an event. FIG. 17 shows a screen that can he used by study participants to record the time of an event or create a journal entry related to the event. This screen may be displayed when the study participant clicks or taps on 132 in FIG. 16.

Continuing to refer to FIG. 2, element 62 can be a button that enables creator to deploy a study to the deployment server 8 in FIG. 1. Once the study is deployed it may be available for potential participants to sign up and take part in a study. There may be many other steps involved in the creation of a study including creating a micro site for the study that includes blogs, discussions, landing pages, etc.

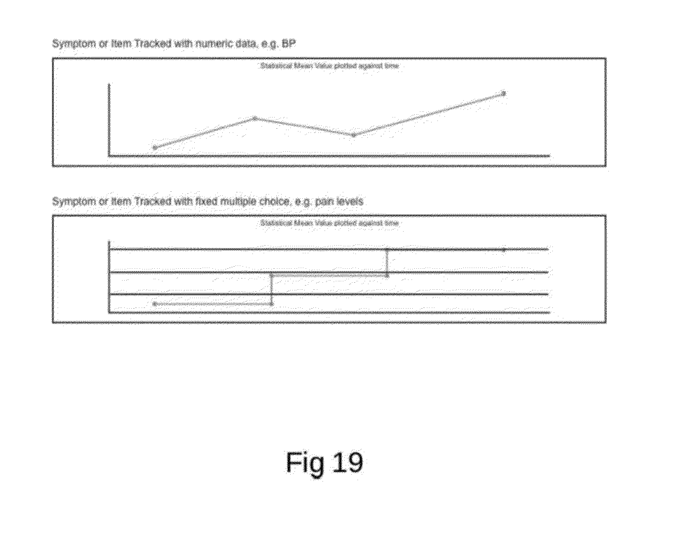

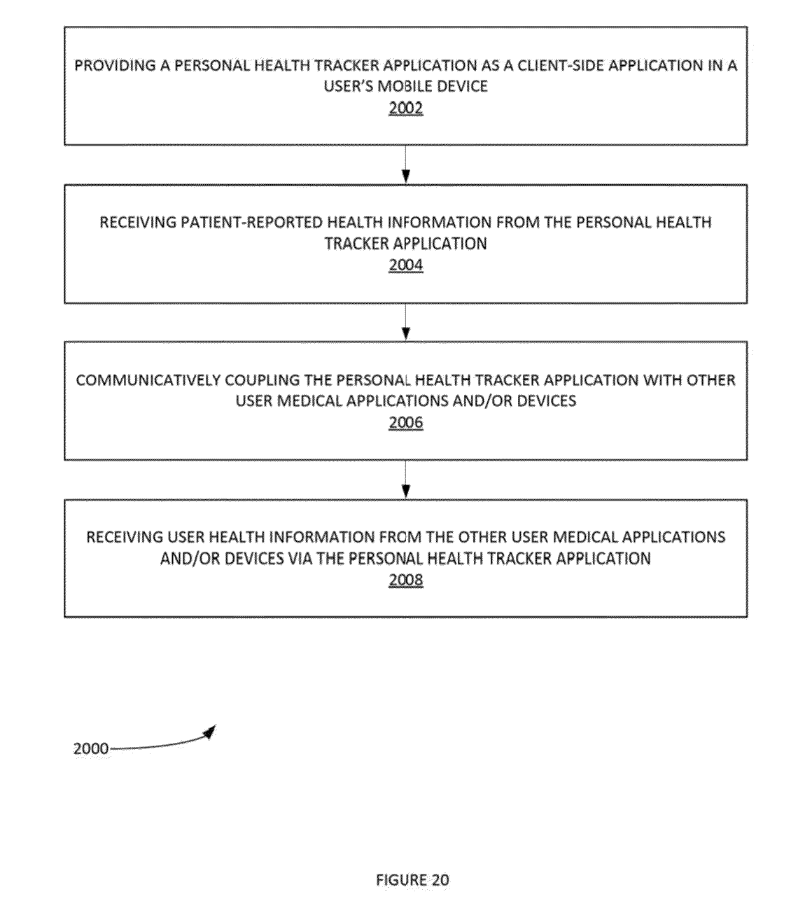

Once the study is underway, all study data may be synced to a centralized database on 8. Once the data is aggregated; the study data can be analyzed for meaningful trends and correlations. In order to keep study compliance level high, any activity missed by the participant may cause a reminder to be generated. FIG. 18 shows the list a participant may continue to see until either the activity is completed or the participant clicks the do not display check box. Once the study is underway individual data from different participants may be aggregated and analyzed. Many different graphs and reports may be produced to enable the analysis of the data captured in a study. One representation of study data in the form of line graphs is shown in FIG. 19.

The studies created using some embodiments may also include a study level associated with it. A level may be awarded to a study by an ‘award committee’ constituted by a governing body that may oversee all studies conducted using some embodiments. The levels may relate to degree of adherence to commonly accepted scientific principles for conducting studies in general and in health care in particular. The governing body at its sole discretion may define the levels and the criteria used to judge eligibility to qualify for a level. Study creators may have the ability to request that a specific level be awarded to their study. The ‘award committee’ may then assess if the study is eligible for the requested level.

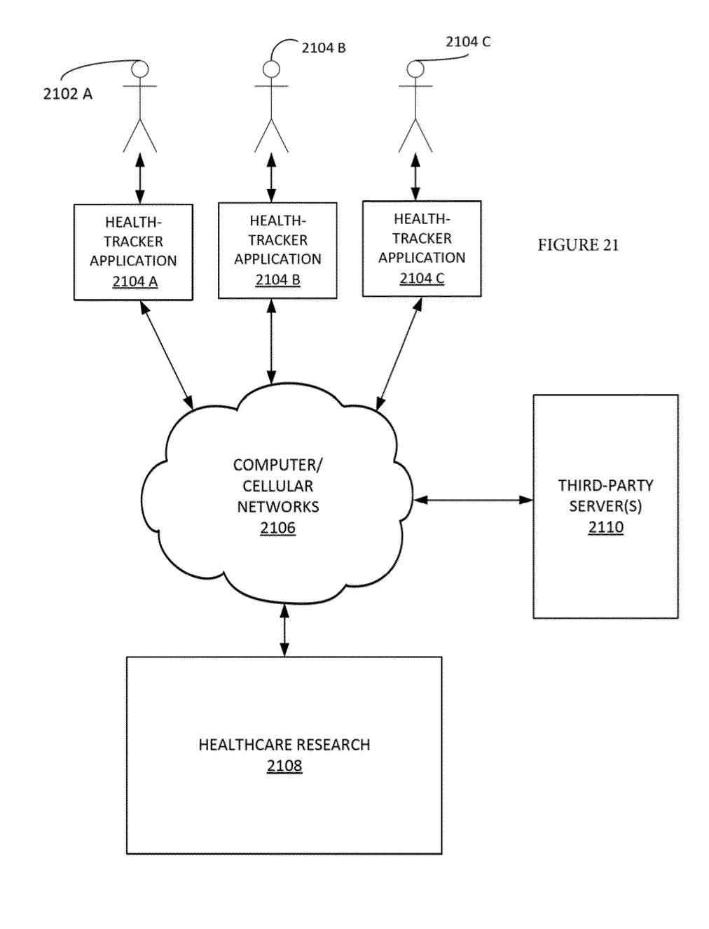

FIG. 20 illustrates an example process 2000 of obtaining user health information via a health-tracker application in a mobile device, according to some embodiments, in step 2002, a personal health tracker application can be provided as a client-side application in a user's mobile device. For example, a user can download the health-tracker application from an application store and/or a healthcare management provider's website. The health-tracker application can be compatible with to variety of mobile device operating systems. It is noted that the health-tracker application can password protected and/or utilize various successful user authentication steps to access. Additionally, the health-tracker application can be presented under a non-health related name in the mobile device. In this way, a user's health-related information can be protected as well as providing the user the ability to discreetly input health-related information into the application in a public environment. In step 2004, the patient-reported health-related information can be received from the personal-health tracker application. For example, the health-related information can be aggregated into a centralized server, set of servers and/or cloud-computing environment to analytics and processing. The health-related information can be encrypted and/or otherwise anonymized during transmission in a computer network in order to further preserve the privacy of the user. It is noted that the mobile device can communicatively couple with other user devices such as computerized-medical devices (e.g. via a wireless local network such as Bluetooth®). Additionally, a user may wear certain biomedical and environmental devices and/or sensors. Thus, in step 2006, the personal health tracker application can also communicatively couple with other user medical applications and/or devices. The information from said devices can be automatically uploaded to the personal health tracker application (e.g. based on certain trigger events and/or on a periodic basis).

Exemplary Computing Systems and Architecture

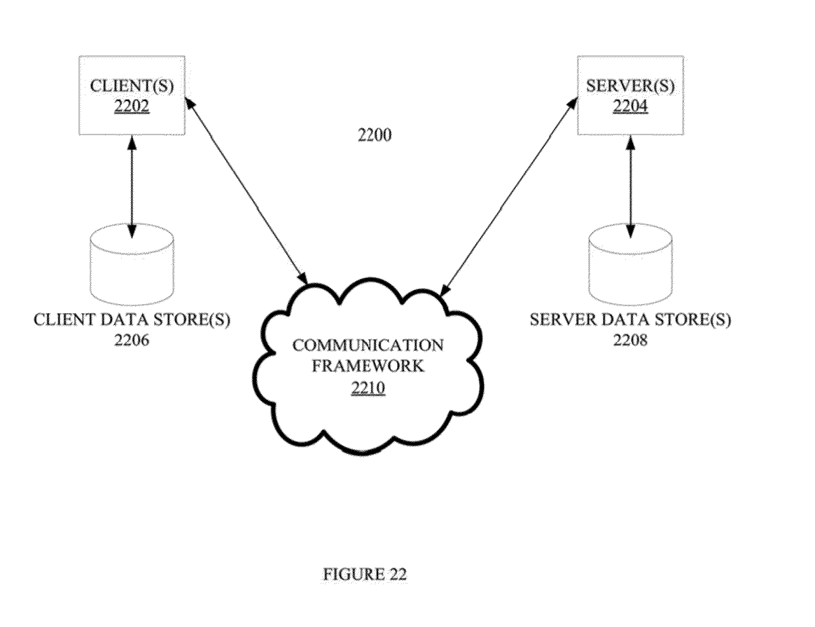

FIG. 21 depicts an exemplary system for implementing, a crowed-sourced healthcare research system, according to some embodiments. Users 2102 A-C can provide (e.g. manually input, upload from a wearable biosensor, etc.) user-health information via a health-tracker applications 2104 A-C. Health-tracker applications 2104 A-C can be implemented in various computing devices (e.g. mobile devices, personal computers, laptops, wearable computers, etc.). These computing devices can include one or more sensors configured to obtained medical and/or other information about users 2102 A-C. Health-tracker applications 2104 A-C can include various functionalities and interfaces as provided herein (e.g. user interfaces provided in FIGS. 24-63, the healthcare tracker application provided in the description of process 2000, and the like). User-health information can then be communicated (e.g. via various computer and/or cellular network 2106) to various remote servers such as health-care research server 2108 and/or third-party servers 2110. It is noted that remote servers can be implemented in a cloud-computing environment. Health-care research server 2108 can include functionalities for managing health-tracker applications 2104 A-C. Furthermore, health-care research server 2108 can include any functionalities for supporting the server-side processes provided process 2000 and/or FIGS. 24-63. Although not shown for purposes of clarity, health-care research server 2108 can further communicate with and/or manage various databases and/or other application programming interfaces. In this way, health-care research server 2108 can obtain additional biographical, demographic and/or medical information about users 2102 A-C in addition to information provided via health-tracker applications 2104 A-C.

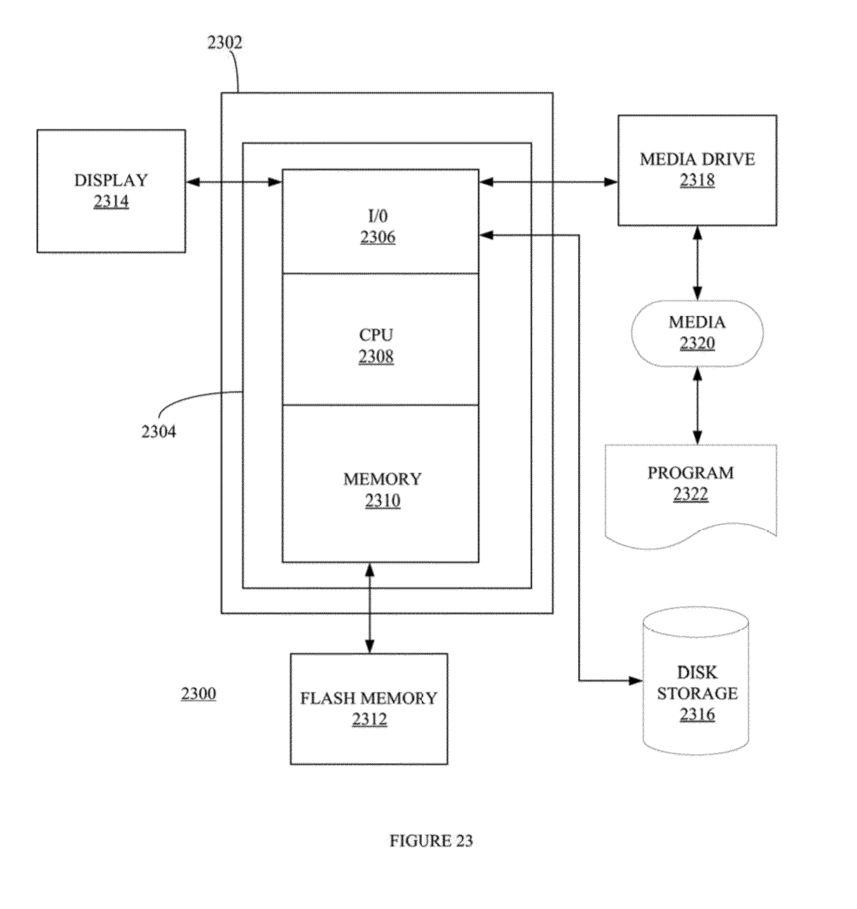

FIG. 22 depicts an exemplary computing system 2200 that can be configured to perform any one of the processes provided herein. In this context, computing system 2200 may include, for example, a processor, memory, storage, and I/O devices (e.g. monitor, keyboard, disk drive. Internet connection, etc.). However, computing system 2200 may include circuitry or other specialized hardware for carrying out sonic or all aspects of the processes. In some operational settings, computing system 2200 may be configured as a system that includes one or more units, each of which is configured to carry out some aspects of the processes either in software, hardware, or some combination thereof.

FIG. 22 depicts computing system 2200 with a number of components that may be used to perform any of the processes described herein. The main system 2202 includes a mother-board 2204 having an I/O section 2206, one or more central processing units (CPU) 2208, and a memory section 2210, which may have a flash memory card 2212 related to it. The I/O section 2206 can be connected to a display 2214, a keyboard and/or other user input (not shown), a disk storage unit 2216, and a media drive unit 2218. The media drive unit 2218 can read/write a computer-readable medium 2220, which can include programs 2222 and/or data.

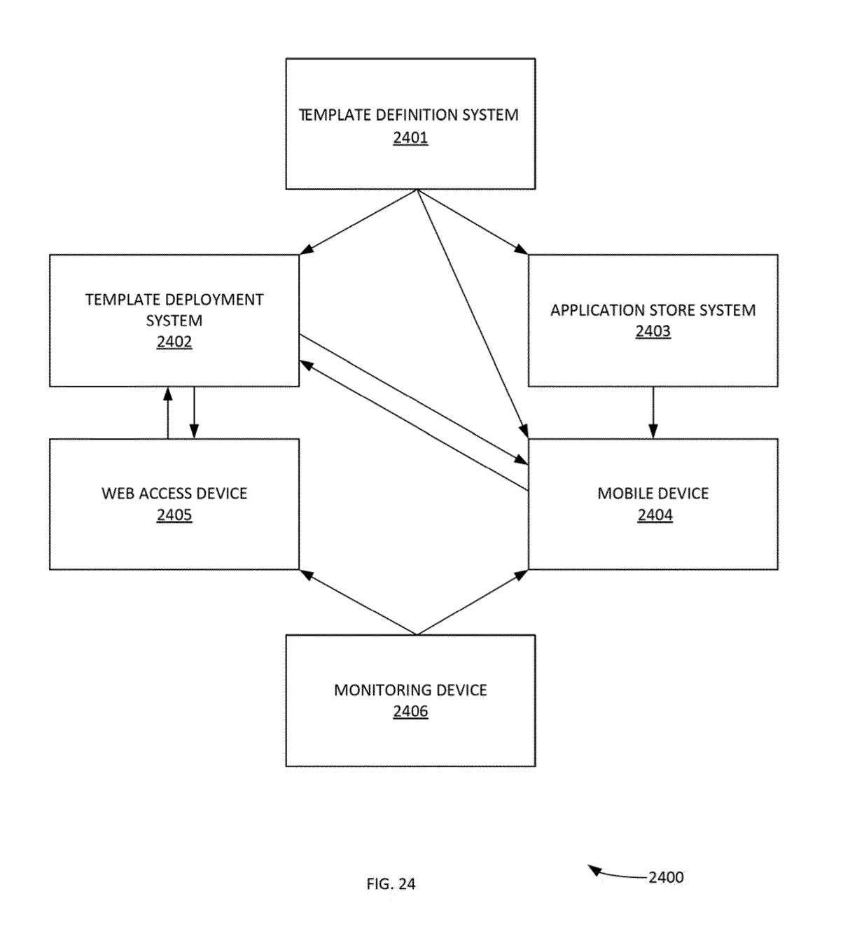

FIG. 23 is a block diagram of a sample computing environment 2300 that can be utilized to implement some embodiments. The system 2300 further illustrates a system that includes one or more client(s) 2302. The client(s) 2302 can be hardware and/or software (e.g., threads, processes, computing devices). The system 2300 also includes one or more server(s) 2304. The server(s) 2304 can also be hardware and/or software (e.g., threads, processes, computing devices). One possible communication between a client 2302 and a server 2304 may be in the form of a data packet adapted to be transmitted between two or more computer processes. The system 2300 includes a communication framework 2310 that can be employed to facilitate communications between the client(s) 2302 and the server(s) 2304. The client(s) 2302 are connected to one or more client data store(s) 2306 that can be employed to store information local to the client(s) 2302. Similarly, the server(s) 2304 are connected to one or more server data store(s) 2308 that can be employed to store information local to the server(s) 2304.

In some embodiments, system 2300 can be include and/or be utilized by the various systems and/or methods described herein to implement any of the process and/or examples provided supra. Client 2302 can be in an application such as a web browser, augmented reality application, text messaging application, email application, instant messaging application, etc.) operating on a computer such as a personal computer, laptop computer, mobile device (e.g. a smart phone) and/or a tablet computer. In some embodiments, computing environment 2300 can be implemented with the server(s) 2304 and/or data store(s) 2308 implemented in a cloud computing environment.

Example Embodiments of a Template Definition System

Another embodiment of the system in FIG. 2 is shown in FIG. 24, ‘Study Definition System’ 2 can be replaced by a ‘Template Definition System’ 2401 and ‘Study Deployment System’ 8 can be replaced by a ‘Template Deployment System’ 2402. In this embodiment the system depicted in FIG. 2 through FIG. 19 can be used to define templates. These templates can list a set of health-care related needs to be tracked for a specific disease and/or a health goal. System 2400 can be implemented without a central study administrator that decides what is to be tracked. Instead users can pick one or more templates and customize each template for his/her own use. A user can download the template ‘as is’ and/or customized to a ‘metadata interpreter’ application or program. The ‘metadata interpreter’ application or program can be downloaded from distribution point ‘Application Store System’ 2403. In some examples, a ‘metadata interpreter’ application and/or program can be distributed via other means such as a web site and/or a portable storage media. In sonic embodiments, the ‘metadata interpreter’ application and/or program can be setup just once, afterwards the user of the application can mix and match templates to download in order to add functionality and/or remove functionality from the application. Many user can have co-morbidities and/or have multiple health goals to pursue at the same time. By having one ‘metadata interpreter’ application and/or program on a mobile communication and computing device 2404 (e.g. a smart phone, a tablet computer, a head-mounted display computer and/or other wearable computing devices such as, for example, smart watches, etc.) and/or Web Access Device 2405 in FIG. 24 that can interpret various sets of templates a user can use one ‘metadata interpreter’ application or program to track health issues. Without such a ‘metadata interpreter’ application and/or program and a template system as defined above a user may have to download multiple application systems for their various health tracking goals.

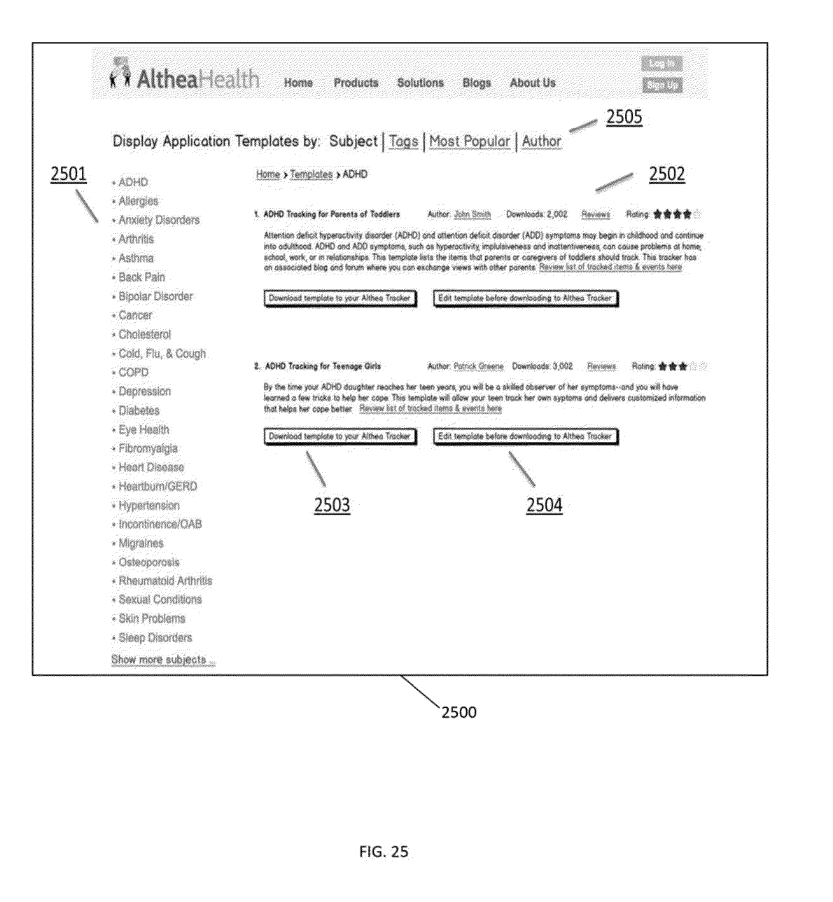

FIG. 25 shows one embodiment of a ‘Template Deployment System’, according to some embodiments. Element 2501 depicts various available subject matters for templates. When a user clicks on a subject various templates available for that subject can be displayed. Element 2502 illustrates one example in which details of a template can be rendered. In this particular example, details such as ratings by other users and/or experts can be depicted by a star system (e.g. other users and/or invited experts can rate a template by various criteria by using, some kind of rating system). In this embodiment, the rating system can enable a user rating the template to provide, for example, five (5) stars to a template that considered ‘very good’ and/or ‘complete’. The user can be enabled to rate another template one (1) star for a system considered ‘poor’. The average from multiple users can be calculated and depicted as well. The user can sign up for a template by clicking on the button 2503. The user can the associate the template with the user's own ‘metadata interpreter’ application and/or program. Button 2504 can enable the user to edit a template and/or otherwise customize it for their own circumstances before associating the customized template with their ‘metadata interpreter’ applications or programs. A plurality of templates can be rated through a system where a user can try to understand which template is best rated by others (e.g. experts knowledgeable in the field or other patients that are experienced in the field). The rating system can include a ‘people like you’ feature that can examine ratings from people who have a health profile similar to the profile of the person making the template selection.

In one embodiment of the a ‘Template Deployment System’ shown in FIG. 25 a user may choose a template and use a feature “rated by other's like you” to see what are the ratings for templates given by other users who have a health profile similar to the user. E.g. the same demographic profile, same geography, same symptoms, etc. The user gets to choose which para,meter is most important for them while filtering ratings based on profiles of people who have provided ratings for a template.

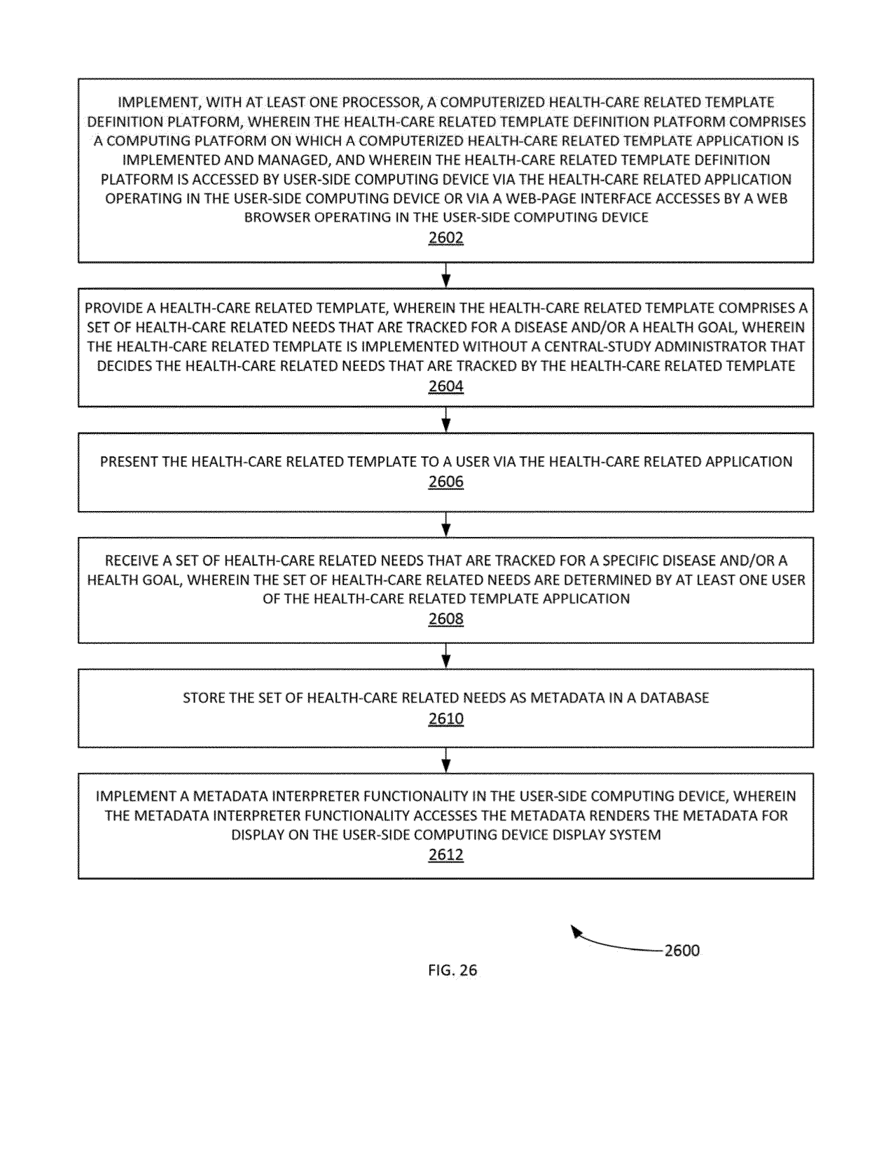

FIG. 26 illustrates an example process 2600 of deploying health-care related templates, according to some embodiments. In step 2602, process 2600 implements, with at least one processor, a computerized health-care related template definition platform. The health-care related template definition platform can include a computing platform on which a computerized health-care related template application is implemented and managed. The health-care related template definition platform is accessed by user-side computing device via the health-care related application operating in the user-side computing device or via a web-page interface accesses by a web browser operating, in the user-side computing device. In step 2604, process 2600 provides a health-care related template. The health-care related template can include a set of health-care related needs that are tracked for a disease and/or a health goal. The health-care related template can be implemented without a central-study administrator that decides the health-care related needs that are tracked by the health-care related template. In step 2606, process 2600 presents the health-care related template to a user via the health-care related application. In step 2608, process 2600 receives a set of health-care related needs that are tracked for a specific disease and/or a health goal. The set of health-care related needs can be determined by at least one user of with the health-care related template application. In step 2610, process 2600 stores the set of health-care related needs as metadata in a database. In step 2612, process 2600 provides a metadata interpreter functionality to the user-side computing device. The metadata interpreter functionality can access the metadata and render the metadata for display on the user-side computing device display system. It is noted that process 2600 and/or the other systems and processes of FIGS. 1-25 can be implemented in a cloud-computing environment, in whole or in part, in some example embodiments.

B. Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of deploying health-care related templates comprising:
implementing, with at least one processor, a computerized health-care related template definition and display platform, wherein the health-care related template definition platform comprises a computing platform on Which a computerized health-care related template application is implemented and managed, and wherein the health-care related template definition platform is accessed by user-side computing device via the health-care related native application operating in the user-side computing device or via a web-page interface accesses by a web browser operating in the user-side computing device;
providing a health-care related template, wherein the health-care related template comprises a set of health-care related measurements that are tracked for a disease or a health goal, wherein the health-care related template can be chosen by a user for tracking their own health;
presenting the health-care related template to a user via the healthcare template definition and display platform where the user can choose a template of interest or rate a template of interest;
presenting a method for a template user to customize the template for their own use by changing a measurement or combining one or more templates for their own use.
receiving a set of health-care related measurements that are tracked for a specific disease or a health goal, wherein the set of health-care related needs are determined by at least one user of with the health-care related template application;
storing the set of health-care related measurements as metadata in a database; and
implementing a metadata interpreter functionality in the user-side computing device, wherein the metadata interpreter functionality accesses the metadata and render the metadata for display on the user-side computing device display system for capturing health measurements from user.

2. The method of claim 1, wherein the health-care related template application is associated with a health issue of the user or a person in the care of a user.

3. The method of claim 2, wherein the user has more than one disease or health goal and may user one or more templates to measure and track the goals.

4. The method of claim 3 further comprising:
providing a plurality of health-care related templates, wherein each health-care related template comprises a set of health-care related needs that are tracked for a specific disease or a health goal.

5. The method of claim 4, wherein the metadata interpreter functionality accesses the metadata from each of the plurality of health-care related templates and renders the metadata for a unified display on the user-side computing device display system.

6. The method of claim 5, wherein the metadata is stored in a JavaScript Object Notation (JSON) format.

7. The method of claim 6, wherein the user comprises a health-care study participant or a user interested in tracking their own health data or for someone in their care such as a child or patient.

8. The method of claim 7, wherein the plurality of health-care related templates are rated by experts or patients, and wherein a rating is available to a template user.

9. The method of claim 8, wherein a set of ratings from other template users with similar profiles to the template user are provided to the template user.

10. The method of claim 1, wherein the user-side computing device comprises a consumer owned mobile device.

11. A server system for implementing a template definition and display computing platform comprising:
a processor configured to execute instructions;
a memory containing instructions when executed on the processor, causes the processor to perform operations that:
implement, with at least one processor, a computerized health-care related template definition platform, wherein the health-care related template definition platform comprises a computing platform on which a computerized health-care related template application is implemented and managed, and wherein the health-care related template definition platform is accessed by user-side computing device via the health-care related application operating in the user-side computing device or via a web-page interface accesses by a web browser operating in the user-side computing device;
provide a health-care related template, wherein the health-care related template comprises a set of health-care related measurements that are tracked for a disease or a health goal, wherein the health-care related template is implemented without a central-study administrator that decides the health-care related needs that are tracked by the health-care related template;
present the health-care related template to a user via the health-care related application;
receive a set of health-rate related measurements that are tracked for a specific disease or a health goal, wherein the set of health-care related measurements are determined by at least one user of with the health-care related template application;
store the set of health-care related measurements as metadata in a database; and
provide a metadata interpreter functionality to the user-side computing device, wherein the metadata interpreter functionality accesses the metadata and render the metadata for display on the user-side computing device display system.

12. The server system of claim 11, wherein the health-care related template application is associated with a health issue of the user.

13. The server system of claim 12, wherein the user has more than one disease or health goal.

14. The server system of claim 13, wherein the memory containing instructions when executed on the processor, further causes the processor to perform operations that:
provide a plurality of health-care related templates, wherein each health-care related template comprises a set of health-care related needs that are tracked for a specific disease or a health goal.

15. The server system of claim 14, wherein the metadata interpreter functionality accesses the metadata from each of the plurality of health-care related templates and renders the metadata for a unified display on the user-side computing device display system.

16. The server system of claim 15, wherein the metadata is stored it a JavaScript Object Notation (JSON) format.

17. The server system of claim 16, wherein the user comprises a health-care study participant or a user interested in self tracking their health or the health of another.

18. The server system of claim 17, wherein the user-side computing device comprises a consumer owned mobile device.

19. The server system of claim 18 wherein the user customizes the health-care related template before associating the health-care related template with the metadata interpreter in the user-side computing device.

20. The server system of claim 19, wherein the metadata interpreter is implemented as a web server.
